(19) United States
(12) Patent Application Publication
(10) Pub. No.: US 2024/0019635 A1
(43) Pub. Date: Jan. 18, 2024

(54) POLARIZATION STATE COMPENSATOR

(71) Applicants: KENT STATE UNIVERSITY, Kent, OH (US); FACEBOOK REALITY LABS, Pittsburgh, PA (US)

(72) Inventors: Xiayu FENG, Kent, OH (US); Philip BOS, Kent, OH (US); Yun Han LEE, Pittsburgh, PA (US); Lu LU, Pittsburgh, PA (US)

(21) Appl. No.: 18/039,516

(22) PCT Filed: Dec. 1, 2021
(86) PCT No.: PCT/US2021/061411

§ 371 Date: May 31, 2023

Related U.S. Application Data
(60) Provisional application No. 63/199,004, filed on Dec. 1, 2020.

(51) Int. Cl. G02B 6/27; G02B 6/26; G02B 6/34; G02B 27/01

(52) U.S. Cl. CPC G02B 6/27; G02B 6/262; G02B 6/34; G02B 27/0101; G02B 2027/0118

(57) ABSTRACT

A waveguide assembly includes a waveguide having a first surface and a second surface; an input deflection grating; an output deflection grating; and a first compensator layer on the first surface of the waveguide. The first compensator layer includes a material selected from aligned liquid crystal reactive mesogens, birefringent polymers, and inorganic birefringent materials.

The present application claim the priority benefit of U.S. Provisional Ser. No. 63/199,004, filed Dec. 1, 2020, the content of which are incorporated by reference herein.

### BACKGROUND

The present disclosure relates to polarization state compensators. The polarization state compensators may be useful for waveguides (e.g., based on polarization holography). Optical combiners containing the compensators and waveguides are also disclosed. The optical combiners may be useful for augmented reality (AR) applications.

AR technology superimposes a virtual image on a user's view of the real world, thereby providing a composite view. AR devices generally include at least one display device for generating the virtual image and an optical combiner which reflects the virtual image while transmitting external light, resulting in the virtual image being superimposed over the user's environment.

One design issue with AR devices arises with the combination of a waveguide and input and output couplers. The light of the image generated from the display device needs to be deflected to the waveguide by an input coupler, then to travel in the waveguide by total internal reflection (TIR), and finally to be coupled out to human eyes from the waveguide by an output coupler. The couplers, which are large angle beam deflectors, are difficult to produce in a way that is low cost and of high efficiency. Polarization volume gratings (PVGs) are an interesting candidate for the couplers since they have advantages compared with traditional surface relief gratings and holographic gratings. PVGs can provide a higher index modulation than standard holographic materials (e.g., standard volume Bragg grating materials) that allows a higher deflection efficiency at large angle. Additionally, they are polarization selective which offers more flexibility in device design.

Since PVGs are polarization-dependent, the polarization state of light propagating in a waveguide is a factor in the design of a system that uses them. Exit-pupil expansion design by adding a liquid crystal layer with different azimuthal angles to control output efficiency of the output coupler by tuning the polarization state has been considered. However, the problem of the changes in polarization related to the total internal reflection of light as it propagates in the waveguide, and how to fix that problem, has not been discussed in the literature.

A conventional imaging waveguide includes a slab of transparent material such as glass that incorporates a Bragg deflection grating at the input and output coupler to couple light into the waveguide and to extract it.

The polarization state of light can be changed with total internal reflection. For example, if a left circular polarized incident light, which has S and P modes with the same intensity but phase difference phase P−S=−90°, after TIR, amplitudes stay the same, but the phase difference will be different. This phenomenon was observed in a modeled waveguide by FDTD simulation with the following inputs: n_air=1; n_waveguide=1.625; incident angle=52 degrees; and a computation size of 17 by 4.5 microns. It was observed that after TIR, phase between S and P modes changed far away from −90 degrees to be +36 degree, which is in agreement with the Fresnel equations.

A shortcoming of this approach is that the Bragg gratings, formed using standard holographic techniques have a low efficiency. The use of polarization gratings has been proposed to aid in the solution to the problem of low efficiency of the input and output coupling gratings. The polarization grating could offer other advantages such as allowing for polarization selective effects.

In a constructed device, the output efficiency was much lower than expected. In the case of polarization gratings, the light leaving the input grating has a particular polarization state of light, and that it must be in a particular state when it reaches the output grating if high efficiency is to be obtained. The problem is that the polarization state of light traveling down the waveguide is substantially altered according to experimental simulations.

There is a need for compensators that address this issue.

### BRIEF DESCRIPTION

Disclosed, in some embodiments, is a waveguide assembly including: a waveguide having a first surface and a second surface; an input deflection grating; an output deflection grating; and a first compensator layer on the first surface of the waveguide. The first compensator layer contains a first material selected from aligned liquid crystal reactive mesogens, birefringent polymers, and inorganic birefringent materials.

The input deflection grating and the output deflection grating may be located on the first surface or the second surface of the waveguide. The gratings may be located on the same or different surfaces.

In some embodiments, the first compensator layer has an optical axis aligned perpendicular to a direction of light propagation in the waveguide.

The waveguide assembly may further include a second compensator layer on the second surface of the waveguide. The second compensator layer may include a second material selected from aligned liquid crystal reactive mesogens, birefringent polymers, and inorganic birefringent materials. The first and second materials may be the same or different. When multiple compensators are included, they may have the same or different thicknesses.

In some embodiments, the first compensator layer is continuous. In other embodiments, the first compensator layer is discontinuous. When multiple compensators are included, they may both be continuous. In other embodiments, they are both discontinuous. In further embodiments, one compensator may be continuous and another compensator may be discontinuous.

Disclosed, in other embodiments, is an optical combiner including: a transparent waveguide layer; an input coupler attached to a first surface or a second surface of the transparent waveguide layer; an output coupler attached to the first surface or the second surface of the transparent waveguide layer; and a compensation layer attached to the first surface or the second surface of the transparent waveguide layer. The compensation layer includes a material selected from aligned liquid crystal reactive mesogens, birefringent polymers, and inorganic birefringent materials.

At least one of the input coupler and the output coupler may include a polarization volume grating.

In some embodiments, the compensation layer has a thickness in a range of about 10 nm to about 100 μm.

The material may have a birefringence (nₑ-nₒ) in a range of about −0.5 to about 0.5.

In some embodiments, the compensation layer is attached to the first surface; and the input coupler and the output couple are attached to the second surface.

The compensation layer may cover at least 85% of the first surface.

In some embodiments, the optical combiner includes a second compensation layer attached to the second surface between the input coupler and the output coupler.

Disclosed, in further embodiments, is an augmented display system including: a display source; and an optical combiner containing: a waveguide; an input coupler on a first surface or a second surface of the waveguide, the input coupler configured to receive an image from the display source; an output coupler on a first surface or a second surface of the waveguide, the output coupler configured to transmit the image to a user; and a polarization compensator on a first surface or a second surface of the waveguide, the polarization compensator configured to correct polarization of light transmitted through the waveguide.

The augmented display system may be an augmented reality (AR) system or a heads up display (HUD) system.

In some embodiments, the augmented display system is wearable. In other embodiments, the augmented display system is part of a window (e.g., of a vehicle or a building).

These and other non-limiting characteristics are more particularly described below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a schematic illustration of a compensated waveguide display system in accordance with some embodiments of the present disclosure.

FIG. 2 illustrates cross-sectional views of different compensators with different optical axes in accordance with some embodiments of the present disclosure.

FIG. 3 is a cross-sectional view of a compensated imaging waveguide system with one bounce in accordance with some embodiments of the present disclosure.

FIG. 4 is a cross-sectional view of a compensated imaging waveguide system with two compensator elements configured for a plurality of bounces in accordance with some embodiments of the present disclosure.

FIG. 5 is a cross-sectional view of a compensated imaging waveguide system with one compensator element configured for a plurality of bounces in accordance with some embodiments of the present disclosure.

FIG. 6 is a cross-sectional view of a compensated imaging waveguide system with one compensator element covering a relatively small area configured for a plurality of bounces in accordance with some embodiments of the present disclosure.

FIG. 7 is a schematic illustration of a basic waveguide structure, where a compensator just after the input coupler and before output coupler is shown. Coordinates used of the graphs is with X and Z axis in paper plane, and Y axis points out of paper plane.

FIG. 8 illustrates various axes as discussed in the Examples.

### DETAILED DESCRIPTION

The present disclosure may be understood more readily by reference to the following detailed description of desired embodiments included therein. In the following specification and the claims which follow, reference will be made to a number of terms which shall be defined to have the following meanings.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent can be used in practice or testing of the present disclosure. All publications, patent applications, patents, and other references mentioned herein are incorporated by reference in their entirety. The materials, methods, and articles disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases that require the presence of the named ingredients/steps and permit the presence of other ingredients/steps. However, such description should be construed as also describing compositions, mixtures, or processes as “consisting of” and “consisting essentially of” the enumerated ingredients/steps, which allows the presence of only the named ingredients/steps, along with any impurities that might result therefrom, and excludes other ingredients/steps.

Unless indicated to the contrary, the numerical values in the specification should be understood to include numerical values which are the same when reduced to the same number of significant figures and numerical values which differ from the stated value by less than the experimental error of the conventional measurement technique of the type used to determine the particular value.

All ranges disclosed herein are inclusive of the recited endpoint and independently combinable (for example, the range of “from 2 to 10” is inclusive of the endpoints, 2 and 10, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

Polarization holography offers advantages over conventional holograms in the application of input and output optical couplers for imaging waveguides used in “heads up” displays and Augmented Reality devices. One advantage is that each of a pair of input and output gratings in the same waveguide can be selected by their polarization state. However, a polarization state change caused by internal reflection in a waveguide makes this approach unusable. The present disclosure solves this problem by applying at least one compensator film to at least one surface of the waveguide.

The compensator film allows polarization holograms to be used in waveguide applications. This has the advantage of allowing the use of the polarization state of light to render the particular hologram active or inactive. This can be used to provide white light input and output waveguide couplers for example.

Light traveling down the waveguide of an AR device can experience polarization state changes due to the difference in the phase of the TIR reflected p and s polarized light components. If the waveguide uses a polarization-based output coupler that has high efficiency for circularly polarized light, the change in polarization of light propagating down the waveguide is a problem. The nature of this problem and designs of compensators that can be used to substantially reduce or eliminate it are disclosed herein.

The design of a birefringent compensator which can be applied in waveguide system, to allow the polarization state of light after TIR to maintain a circular polarization state is described herein. Evaluation of the compensator, with multiple TIR reflections, has been investigated.

In some embodiments, a compensator is applied over the entirety or substantially the entirety of at least one surface of a waveguide to compensate the light after every TIR being circularly polarized. This compensator may be particularly useful for several TIR reflections. For long distance wave propagation in the waveguide and/or to use a very thin waveguide, the polarization state control may be less effective since a small compensation error is accumulated in every TIR reflection. At the end of waveguide, light from all directions and with different TIR numbers is in the same polarization state.

The polarization state of linear polarized light (LP) S (SLP) or P (PLP) mode, does not change in a waveguide due to total internal reflections. In some embodiments, linear polarized light is used in waveguide propagation, and converted to circular polarized light at the input and output of the waveguide which are using polarization volume gratings working for circular polarized light. By this method, the efficiency of the waveguide system is almost independent with the number of TIR reflections.

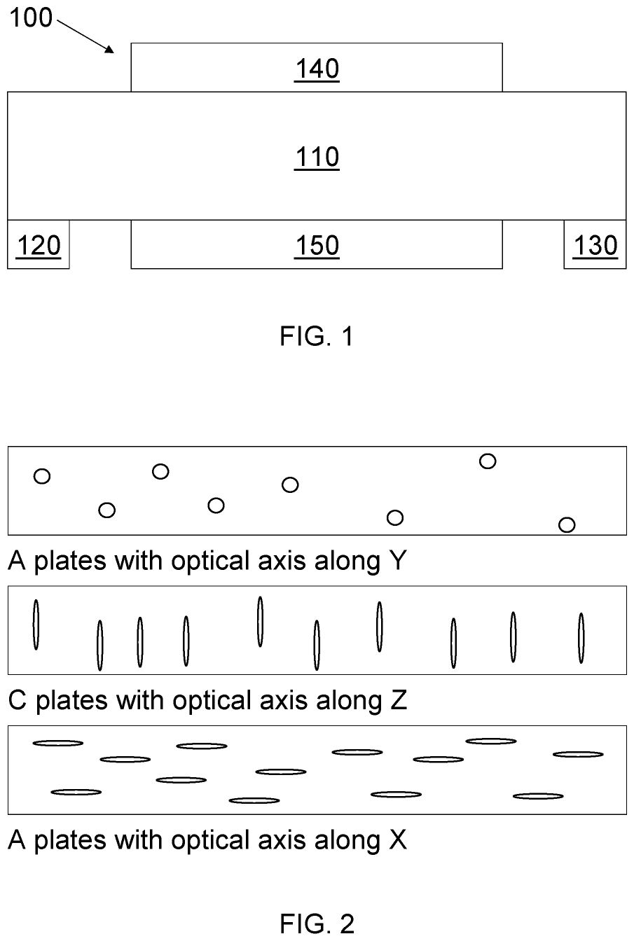

FIG. 1 schematically illustrates a compensated waveguide 100 for multiple-times TIR in a waveguide (cross section), with coordinates (not labeled in FIG. 1) X points right, Z points up, and Y perpendicular to the X-Z plane. The compensated waveguide 100 includes waveguide 110, input coupler 120, output coupler 130, first compensation layer 140, and second compensation layer 150. The compensation layers may also be referred to as compensators or compensator films.

In a waveguide system, light comes from different angles and with different numbers of TIR reflections. This makes polarization state control of light getting to the output coupler difficult.

One way to solve this problem is to apply the compensator everywhere along the waveguide-air interface, and control light to be in a circular polarized state after every TIR reflection. At the end of waveguide, light from all directions is in the same polarization state.

Applying a birefringent layer or a stack containing multiple layers (which are referred to herein as compensators) on the outside of the waveguide addresses the problem. The orientation of the optical axis of compensator and the thickness of the compensator with given birefringence may be selected based on the needs of a particular application.

In considering applying a birefringence retarder to compensate this phase shift, several example configurations include:
Positive A plate with optical axis along X axis: Ax+;
Negative A plate with optical axis along X axis: Ax−;
Positive A plate with optical axis along Y axis: Ay+;
Negative A plate with optical axis along Y axis: Ay−;
Positive C plate with optical axis along Z axis: C+; and
Negative C plate with optical axis along Z axis: C−.

An “A plate” is a retarder with optical axis on the retarder plane.

A “C plate” is a retarder with optical axis perpendicular to the retarder plane.

The compensators may have a birefringence (nₑ-nₒ) in the range of about −0.5 to about 0.5 and/or a thickness in the range of about 10 nm to about 100 μm.

FIG. 2 illustrates different compensators with different optical axes.

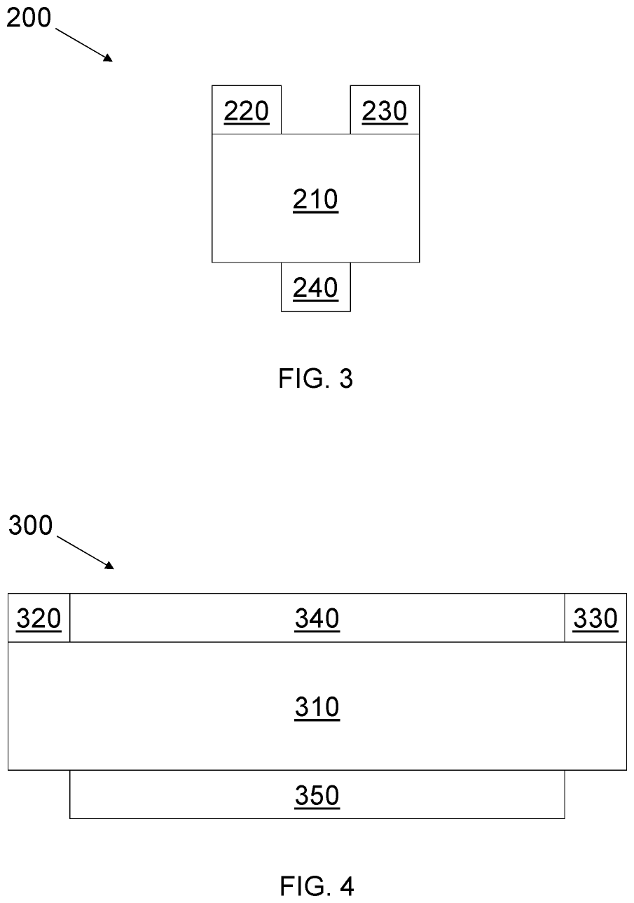

FIG. 3 illustrates another embodiment of a compensated waveguide display system 200. The system 200 includes waveguide 210, input coupler 220, output coupler 230, and compensation layer 240 on the side of the waveguide 210 opposite the couplers 220, 230. This system 200 may be configured for one bounce of light.

FIG. 4 illustrates a further embodiment of a compensated waveguide display system 300. The system 300 may be configured for multiple bounces of light and includes waveguide 310, input coupler 320, output coupler 330, first compensation layer 340 between the couplers 320, 330, and second compensation layer 350 on the side of the waveguide 310 opposite the couplers 320, 330.

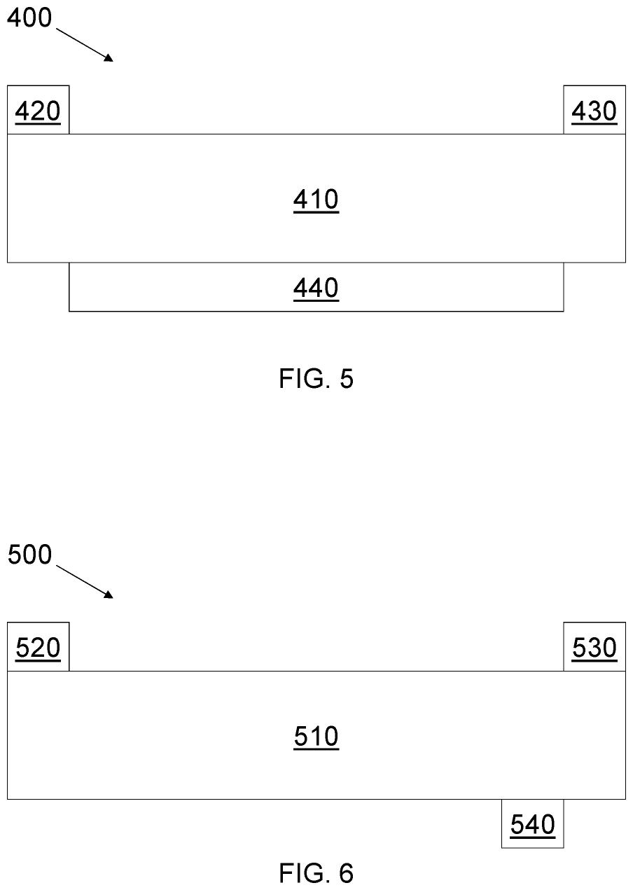

FIG. 5 illustrates another embodiment of a compensated waveguide display system 400. The system 400 may be configured for multiple bounces of light and includes waveguide 410, input coupler 420, output coupler 430, and compensation layer 440 on the side of the waveguide 410 opposite the couplers 420, 430.

FIG. 6 illustrates another embodiment of a compensated waveguide display system 500. The system 500 may be configured for multiple bounces of light and includes waveguide 510, input coupler 520, output coupler 530, and compensation layer 540 on the side of the waveguide 510 opposite the couplers 520, 530. The compensation layer 540 covers a smaller portion of the surface of the waveguide 510.

Combinations, such as like two or three different compensator elements in a stack, are also contemplated.

The compensators may contain aligned liquid crystal reactive mesogens, birefringent polymers, inorganic birefringent materials, and/or birefringent organic materials.

Non-limiting examples of liquid crystal reactive mesogens include RM 257 from Merck.

Non-limiting examples of birefringent polymers include polycarbonates.

Non-limiting examples of inorganic birefringent materials include at least one spatially patterned layer of SiO₂.

The compensator can be applied on a surface of waveguide. The film could be coated over both surfaces of a waveguide with one bounce or multiple bounces. Alternatively, it could be that the retardation effects of the two polymer layers could be “added” together to allow the film to be only on one layer, or only in one area of one layer. The criteria are that the polarization state of the light incident on the output coupler is of the desired polarization state.

Since the polarization state of light input and output in a waveguide can be different according to detailed application requirements, the optical axis, and/or thickness of compensator can be different. With the compensator applied in accordance with some embodiments of the present disclosure, output polarization state in waveguide can be the state with large acceptable light propagating angle range expected.

In some embodiments, light with left hand circular polarized light is provided into the waveguide with wide incident angle and expected to have right hand circular polarized light output of waveguide.

The waveguide may have index 1.7. When the compensator can be chosen from six elements listed above, the compensator may include Positive A plate with optical axis along X axis: Ax+.

Generally speaking, the angular performance of some options may not match with the angular behavior of interface phase shift by total internal reflection. A positive A plate with optical axis along X axis: Ax+ has angular retardation relation best matching with TIR phase shift in interface.

With different plates as compensators applied, it can be seen that Ax+ (positive A plates with optical axis along X axis) has the best performance which could provide output S3>0.95 with large incident angle range with one-time TIR and compensation. Ax+ works because the curve of retardation matches with curve of TIR phase shift well.

In some embodiments, the compensated waveguide display can have birefringence with nₑ=1.705, nₒ=1.695, and thickness=6.7 microns. The parameters of compensator can be different, for example with larger birefringence and smaller thickness.

There are many options to compensate incident circular polarized light to reflected circular polarized light. One is to subtract the phase shift due to TIR to cause the reflected light to have the same polarization state it had before the reflection. But there are other options: for example, if the incident light was LHC, which has phase P— phase S=−90 degrees: With compensator applied, reflected light phase P— phase S can be 90 degrees (RHC), 270 degrees (LHC) or −270 degrees (RHC) or even larger phase difference.

In some embodiments, a method for selecting a good retarder to be used as a compensator include:
Choosing one of the elements in Ax+, Ay− and C+, and calculating the TIR phase shift at the compensator-air interface using modified Fresnel equations.
With the incident angle=55 degrees, solving the analytic retarder equations. For given values of nₒ and nₑ, for the needed thickness of the retarder to allow the phase shift of the retarder+TIR phase shift=180 degrees.
Using this value to plot the combined retardation for all relevant angles of incidence, to establish if the retarder configuration is viable.
With the best retarder configuration, using the more accurate Berreman method to optimize the retarder values and to predict the efficiency of the combined system.

In some embodiments, the compensator(s) include a birefringent material. The birefringent material may be a uniaxial or a biaxial birefringent material. The birefringent material may include at least one of a birefringent ceramic material, a birefringent polymer (e.g., polyethylene naphthalate, polyethylene terephthalate, polycarbonates), an aligned organic molecule (e.g., a single crystal organic molecule such as anthracene), and/or an aligned liquid crystal polymer. This material may be applied to the waveguide using application/deposition methods known in the art.

The birefringent material may have a birefringence greater than or equal to about 0.01, including greater than or equal to about 0.05, greater than or equal to about 0.1, greater than or equal to about 0.15, greater than or equal to about 0.2, and greater than or equal to about 0.25. In some embodiments, the birefringent material has a birefringence of less than or equal to about 0.5.

Other aspects of augmented reality devices are well known in the art and described, for example, in U.S. Pat. Nos. 10,185,393; 10,670,928; 11,099,412; and 11,143,875. The contents of these patents are incorporated by reference herein.

The following examples are provided to illustrate the devices and methods of the present disclosure. The examples are merely illustrative and are not intended to limit the disclosure to the materials, conditions, or process parameters set forth therein.

### EXAMPLES

To evaluate the performance of compensators, results can be plotted by field of view in from of human eyes with efficiency.

Polarization State without Compensator:

Without a compensator applied, with incident LHC, after one-time TIR reflection, S3 shifts from −1 to 0.53-0.91 with different incident angles by the calculation methods shown above. With 9 TIR reflections, there is only a small angular range with S3>0.8. When a polarization grating is applied as the output coupler, the angular range with high efficiency would be low.

With incident LHC and light propagating in a waveguide, after one-time TIR reflection, efficiency is not uniform with different incident angles. With 9 TIR reflections, there is only a small angular range with efficiency>90%. When a polarization grating is applied as the output coupler, the angular range with high efficiency would be low.

Compensator in X-Z Plane

According to Fresnel equations, the TIR phase shift at a waveguide-air interface and a compensator-air interface were plotted for a compensated system with waveguide index=1.7, an Ax+ compensator, nₑ=1.7, and nₒ=1.55. This plot showed the phase shift due to TIR is a strong function of the incident angle in the waveguide.

Since the TIR phase shift is between 120 to 180 degrees, it is straightforward that the closest way to achieve circular polarized reflection is to compensate LHC (−90) to RHC (90) which needs total phase shift P— phase S=180 degrees. Then, if the phase shift due to TIR is 120-180 degrees phase shift, 0 to 60° of phase shift should be added with the compensator, rather than subtracting 120-180°. To have positive retardation, Ax+, Ay− or a C+ retarder may be considered. An issue with adding the compensator film is that it will modify the phase shift due to the reflections. With a compensator applied, interface of waveguide-air changed to compensator-air which induces a TIR phase shift that is different from isotropic waveguide-air interface. A curve showing the phase shift on reflection that is expected with a compensator in place can be produced. The phase difference shown in the curve could be considered as the starting point in the design of the retardation of the compensator.

Compensator with 3D incident

Simulation Method:

The analytics equations provide a basic design approach. However, the reflection at the interface of the waveguide and the compensator has not been considered. The Berreman method takes everything into account, and therefore has slightly different results compared to those found with the analytical equations.

To investigate compensator performance in a waveguide system with wide field of view, the Berreman method was then used with a precise solution to Maxwell Equations for structures that have a 1D periodicity (for example, a stack of 2D layers). Starting with an incident k vector in air k_air (kx_air, ky_air, kz_air), according to Snell's Law we obtain the k vector in the waveguide before input coupler: k_waveguide (kx_w, ky_w, kz_w). The input coupler is described by the grating vector k_g (gx, 0, gz) which means grating will deflect incident light to a direction given by the k vector of light in the waveguide to: k_def (kx_def, ky_def, kz_def) which is calculated by, kx_def=kx_w+kx_g, ky_def=ky_w+ky_g, while kz_def is obtained by keeping the amplitude of light constant. Using k_def to define the light incident at the waveguide surface, the Berreman calculation method was used to find the Stokes parameter S3 which equal to 2Es*Ep*sin δ/(Es\hat{ }2+Ep\hat{ }2) (where δ is phase leading from Es to Ep) of light after the TIR reflection and passing through the compensator. This was done with different k_def vectors, corresponding to incident light in air. By using stokes parameter S3, the polarization state of light in waveguide and efficiency of the output coupler can be described. The polarization volume grating efficiency is related to incident light stokes parameter S3. Roughly speaking, its efficiency can be estimated as: Efficiency=(1+S3)/2*100%, if it is assumed that the grating efficiency is ˜100% with designed circular polarized state. In the calculation, we used the index of waveguide=1.7 and critical TIR angle in the waveguide˜36 degrees.

Finally, a graph of S3 in polar coordinates of incident light in air using polar angle=cos kz_air/|k_air|; and azimuthal angle=tan ky_air/kx_air can be plotted. The resulting plot showed the S3 distribution in field of view (FOV) that a user would see. Two dashed lines in the graph corresponded to polar angles 40 and 70 degrees in the waveguide that are the assumed limiting angles. The color bar was set for S3 increments of 0.2, over the range from 0 to 1. For S3 less than 0, corresponding the output coupling efficiency of <50% the color black is used.

Graphs were plotted by field of view in front of eyes.

Polarization state with single layer compensator:

The results above show the necessity for polarization control in a waveguide system that uses an output coupler that requires circularly polarized light. By following the selection steps above, another compensator design was selected. This Ax+ compensator had ne=1.85, no=1.55; with waveguide index 1.7. With this compensator applied, the phase shift due to TIR changed. Starting with that phase shift, the optimized thickness of compensator turned out to be 0.194 micron to have perfect compensation with a 55-degree angle of incidence. With this thickness, the phase shift due to the retarder and the total phase shift with different incident angles were calculated. It is close to 180 degrees with large angle range incident.

Using the parameters, for positive A plates with optical axis along X axis, nₑ=1.85, nₒ=1.55, and thickness=0.24 micron, and n_waveguide=1.7, the critical TIR angle in waveguide-compensator interface is asind(1.55/1.7)=65 degrees. So, the maximum polar angle in waveguide, is set by 65 degrees.

Discussion and improvement

When nₒ<n_waveguide, TIR occurs at the waveguide-compensator interface, which limits FOV.

To avoid this issue, a large value of nₒ for the compensator may be used. While it may be difficult to obtain higher values, for an example of what could be expected, predicted results were calculated for this case. By using the index of compensator nₑ=1.705, nₒ=1.695, and waveguide index 1.7, TIR phase shift and retardation were calculated and plotted. In this case, a wider angle range of appropriate compensation is achieved. Graphs of this idealized system were calculated using the Berreman method. In this case, a larger area with S3 higher than 0 was seen, that corresponds to a larger field of view with high output coupler efficiency.

With this Compensator Applied:

Area with efficiency>90% is much larger, which corresponds with higher efficiency of waveguide system output coupler.

Looking at the TIR induced phase shift of light propagating in a waveguide, the issue of polarization control for a waveguide system using an output coupler that requires circularly polarized light was found. Using a compensator, highly improved polarization state control was achieved to allow a high output coupler efficiency. Further improvement is possible with more layers, or by using biaxial retarders, with optimized index and birefringence, or by using a non-spatially uniform compensator.

To achieve high compensation S3, the use of at least two compensator layers may provide more flexibility to have good compensation with a larger incident angle range. To evaluate compensator options with two layers, the following procedure was used:
1: From the six elements considered above, pick up two of them that do not have the optical axis in the same direction. Always using nₑ, nₒ equal to 1.705 or 1.695 which is close to waveguide 1.7 to avoid interface reflection.
2: Choose two different incident angles in air, for example, polar angle, azimuthal angle=(8, 0) and (8, 180) degrees. For each incident angle, compensation result can be written as function of two thicknesses of two layers, to arrive at two equations which make these two angles have precisely compensation results, by these two equations, thicknesses of two layers can be solved for, and then compensator performance with other incident angles can be considered.

By solving the equations, six conditions are obtained for working to compensate LHC to RHC, and six other conditions working to compensate LHC to LHC. The best condition with two layers includes positive A plate with optical axis along X, and C plate to exhibit the compensation performance. A plate has nₑ=1.705, nₒ=1.695, thickness=6.2 μm, C plate has nₑ=1.705, nₒ=1.695 and thickness=0.171 μm. For one time TIR and compensation, it has large area with compensated polarization state S3 higher than 0.8.

Then, additional simulations with more times TIR and compensation to test the ability of remaining S3 by this compensator was applied. It was seen that with 9 times TIR and compensation, it still has large area with S3 higher than 0.8. Notice that it is still not the real condition in waveguide since incident light with different polar angle will has different propagating step size along waveguide. Finally, in where waveguide output coupler placed, light with different angles might have different TIR and compensation times.

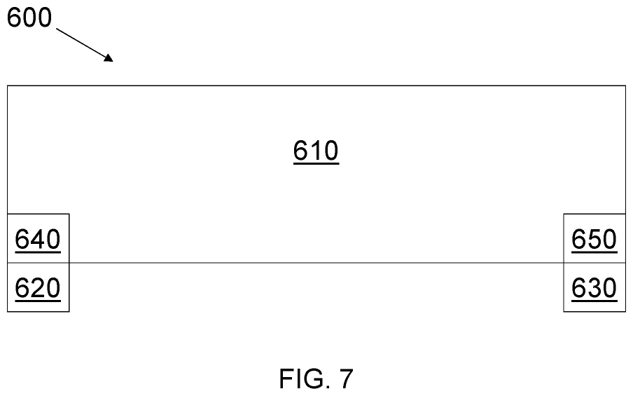

To use linear polarized in waveguide propagation, and convert it back to circular polarized before output coupler, a method was investigated with a birefringent retarder in X-Y plane, with retarder surface normal along Z direction, and retarder placed on top of input and output couplers seen in FIG. 7. The system 600 in FIG. 7 includes waveguide 610, input coupler 620, output coupler 630, first compensator 640, and second compensator 650. In other embodiments, one of the compensators 640, 650 may be omitted. The inclusion of a compensator between the couplers 620, 630 or on the opposite side of the waveguide 610 is also contemplated. The critical design factor is to have optical axis of retarder with non-zero x, y and z components, which mean it is not in X-Y plane. It was verified that with optical axis with non-zero z components, compensator has better performance.

The Berreman method of optical simulation was used.

Data was shown by field of view in front of human eyes with different polar angle and azimuthal angle. The color bar was set by relative efficiency assuming the grating has normalized efficiency “1” with RHC incident, the efficiency is approximately ˜(1+S3)/2*100%. The Berreman algorithm was used in the transmissive mode with two optical elements, one is a retarder used as the compensator, and the other is bottom glass as the waveguide. The bottom glass has thickness 10 micron with index 1.55, and the retarder has ne=1.70, no=1.55. Wavelengths used are 532 nm for green, 633 nm for red, and 457 nm for blue. The angle of light in the waveguide is varied from 37 to 75 degrees polar angle and −15 to 15 degrees azimuthal angle. Direction of light propagation, and direction of optical axis of compensator, can be determined by polar angle and azimuthal angle. The polar angle is measured from Z axis and the azimuthal angle is defined as the angle between the projection of the optical axis (or light k vector) on the X-Y plane, and the X axis.

Compensator optical axis direction analysis:

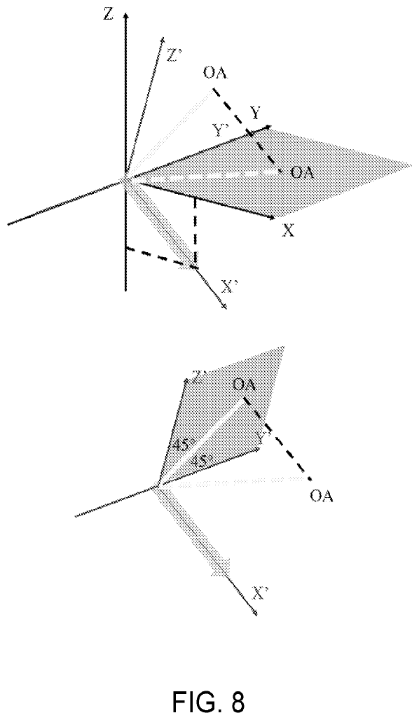

With reference to the coordinates X-Y-Z in FIG. 8, Z is waveguide normal direction and vertical and Y goes into plane. X is horizontal. The polar angle is measured from Z axis and the azimuthal angle is defined as the angle between the projection of the optical axis (or light k vector) on the X-Y plane, and the X axis.

To convert S or P mode linear polarized light with large FOV to circular polarized light, a compensator with certain thickness and with optical axis in a certain direction will be designed. The method to find the optimized parameters of compensator optical axis direction and thickness is listed below:
1: focus on one certain incident angle, it could be a good choice to choose the central of the FOV. For example, here we pick up the on axis incident in X-Z plane with angle 52 degrees. Have incident k vector, K (sin 52, 0, −cos 52).
2: build the coordinates X′-Y′-Z′ used to analysis the optical axis. X′ is direction of k vector of incident, Y′ is the same with Y in coordinates X-Y-Z which goes into plane, and Z′ perpendicular with X′-Y′ plane.
3: to convert S or P modes linear polarized (here S mode linear polarized light is used as an example, which is with electric field along Y′) to circular polarized, it is desired to have compensator optical axis in plane Y′-Z′ having 45 degrees with Y′ axis, or optical axis projection in plane Y′-Z′ is with 45 degrees with Y′ axis.
4: there are two reasonable cases of optical axis direction in compensator:

Case 1, optical axis is in X-Y plane, in this case, compensator is easy to be fabricated using general surface alignment process and spin coated liquid crystal since optical axis in in plane.

Case 2, optical axis is in 3D space, in Y′-Z′ plane which is perpendicular with a picked incident light. In this case, compensator fabrication can be done by 3D holographic alignment material, and off axis performance is better than case 1.

An analytical calculation was made of the optical axis as discussed herein. For case 1, the optical axis has azimuthal angle 31.5 degrees and polar angle 90 degrees. For case 2, the optical axis has azimuthal angle 58 degrees and polar angle 124 degrees. Notice that they are not the rigorous value to have best performance of the whole FOV, they are only the calculation results which point out the direction to have optical axis to have better performance. Typically, the case 2 has better performance with off axis incident and with the large FOV.

5: thickness of compensator can be precisely tested by FDTD simulation according to birefringence. For picked incident angle K (sin 52, 0, −cos 52), in case 1, tested thickness is close to quarter wave/An. For case 2, the tested thickness is close to quarter wave/2Δn. Or we can estimate the suitable thickness of retarder by physical picture. For case 1, since light is tilted incident, when optical axis is in X-Y plane, effective delta n is smaller, but the path length of light is longer. For case 2, the optical axis is in a plane perpendicular with incident k vector, so retardation=path length*effective birefringence. Here n_eff is still the nₑ-nₒ. For example, to have delta n 0.15, and have quarter wave retardation of 532 nm, path length=0.532/4/0.15=0.87 um, since light is incident with 52 degrees, retarder thickness is 0.87*cos 52=0.54 um. Notice that here the calculation is only for one incident angle, to have a view of large FOV performance, the thickness of compensator might be not exactly the same with the calculation result for one incident angle.

Case 2 may offer better off axis performance. In a simulation, optical axis azimuthal angle of 52 degrees and polar angle of 116 degrees were used, close to the calculated results azimuthal angle 58 degrees and polar angle 124 degrees. Typically, the angle close to the calculated angle gives similar performance.

Case 1 optical axis calculation:

Assume the on axis incident, which is the center of FOV in waveguide, is in the X-Z plane with angle 52 degrees. Have incident k vector, K (sin 52, 0, −cos 52). Start with the simple case, optical axis in X-Y plane, have optical axis vector OA in X-Y plane, (cos θ, sin θ, 0).

Angle cos α between these two vector is, OA dot K, got cos α=sin 52*cos θ.

Projection of OA into K, which is along K direction, is, K*sin 52*sin θ, got (sin 52*sin 52*cos θ, 0, −cos 52*sin 52*cos θ)

Projection of OA into a plane which perpendicular with K vector, it is, OA-OA projection in K.

=(cos θ, sin θ, 0)−(sin 52*sin 52*cos θ, 0, −cos 52*sin 52*cos θ)

Got (cos θ−sin 52*sin 52*cos θ, sin θ, cos 52*sin 52*cos θ).

This projection vector should be 45 degrees with X-Z incident plane, to convert LP to RHC or LHC, so x\hat{ }2+z\hat{ }2=y\hat{ }2 in this vector.

(cos θ−sin 52*sin 52*cos θ)\hat{ }2+(cos 52*sin 52*cos 0)\hat{ }2=(sin θ)\hat{ }2

Got tan θ=cos 52

Got θ=31.5 degrees, which is not 45 degrees anymore.

This calculation shows that, to convert LP to RHC, if optical axis is in X-Y plane, it needs to have azimuthal angle 31.5 degrees and polar angle 90 degrees.

Case 2 optical axis calculation:

Assume the on axis incident is in X-Z plane with angle 52 degrees. Have incident k vector, K (sin 52, 0, −cos 52). Optical axis vector OA (x, y, z).

OA (x, y, z) is in a plane perpendicular with incident, so dot product of K and OA is zero.

(sin 52,0,−cos 52)dot(x,y,z)=0

x/z=−cos 52/sin 52

OA (x, y, z) is with 45 degrees with incident plane, so we have

tan 45=y/sqrt(x\hat{ }2+z\hat{ }2),

y\hat{ }2=x\hat{ }2+z\hat{ }2

solved

$$OA ( x , y , z ) = ( \frac{\sqrt{2}}{2} cos 52 , \frac{\sqrt{2}}{2} , - \frac{\sqrt{2}}{2} sin 52 ) .$$

Notice that real optical axis is not a vector but a direction, so the value can be positive and negative.

Azimuthal angle=arctan(y/x)=arctan(1/cos 52)=58 degrees

Polar angle=arctan(sqrt(x\hat{ }2+y\hat{ }2)/z), which is arctan

$$( - \frac{\sqrt{1 + cos {52}^{∧} 2}}{sin 52} ) = 124$$

degrees from positive Z axis.

Simulation Results and Discussion

A. Compensator before output coupler

Starting in the output part of the waveguide, it was assumed light propagating in waveguide is S (SLP) or P (PLP) mode linear polarized light, and desirable to convert them to left hand (LHC) or right hand (RHC) circular polarized light. As an example, the conversion SLP to RHC is discussed.

Compare two cases, with optical axis in plane and out of plane. Case 1 is with optical axis with zero z component which mean optical axis is in X-Y plane, case 2 is with optical axis with non-zero z component. Case 1 has compensator parameters nₑ=1.7, nₒ=1.55, thickness 0.9 micron, optical axis azimuthal angle 31.5 degrees and polar angle degrees, with SLP in. The result is a large area in FOV with relative efficiency >90%, but still with corners efficiency lower than 80% and 70%. Case 2 has nₑ=1.7, nₒ=1.55, polar angle 116 degrees and azimuthal angle 52 degrees, thickness 0.53 micron. Case2 has area with efficiency>90% much larger. Because of this significant improvement by setting optical axis with non-zero z component, out of X-Y plane. The compensator may be modeled with its optical axis with non-zero z component out of X-Y plane.

The effect of the compensator with small or large birefringence, from 0.05 to was considered when keeping the same total retardation Δn*d=79.5 mm. The results show that the performance is almost independent with birefringence, which allows for a wide range of materials to be used for the compensator.

Performance of compensator is verified by finite difference time domain method (FDTD) method. The compensator used here has nₑ=1.7, nₒ=1.55, polar angle 116 degrees and azimuthal angle 52 degrees, thickness 0.53 micron. The SLP mode which only has Ey goes through the compensator with incident polar angle 52 degrees and azimuthal angle 0 degrees, and is converted to circular polarized light after compensator. Read the amplitude and phase of the Ex, Ey and Ez along phase detector, S mode is Ey, P mode projection to X direction is Ex. S mode and P mode amplitude and phase difference δ, the value of S3=2Es*Ep*sin δ/(Es\hat{ }2+Ep\hat{ }2)=0.99 are determined. In summary, the simulation from Berreman method and FDTD matches with each other well.

B. Compensator after input coupler

Above, results are discussed for converting SLP to RHC, by a determined compensator design placed before the output coupler of the waveguide. The same compensator should have the ability to convert input LHC to SLP. By using the same compensator structure and having LHC incident, S mode and P mode amplitude. It can be seen that S mode has large amplitude close to 1, P mode has smaller amplitude close to 0. Graphs were plotted in light k vector space, k vector is normalized to have “1” amplitude by k/ko, graphs have coordinates kx/ko and ky/ko. Component kz/ko was not be plotted which can be calculated by amplitude 1, kx/ko and ky/ko. kx/ko is between −0.58 to 0.95 which corresponds with polar angle of k vector between 37 to 75 degrees, ky/ko is between −0.25 to 0.25 corresponds with azimuthal angle of k vector between −15 to 15 degrees in waveguide. The calculation is done by cos (polar angle)=kz/ko, sin (polar angle)*sin(azimuthal angle)=ky/ko.

C. Combination of input and output compensator

With the demonstrated ability of an input compensator to convert LHC/RHC to SLP/PLP, and a output compensator to convert it back to LHC/RHC, we combine them together to give the evaluation of the whole waveguide system. As an example, we consider having LHC before the input compensator, (the S and P modes have same amplitude and phase P-S=−90 degrees).

Amplitude of S before input compensator: 1

Amplitude of P before input compensator: 1

Phase P-S before input compensator: −90 degrees

It can be seen that after the input compensator, result is not perfect SLP, it has S with large amplitude as a function of light k vector k, P mode with small amplitude as a function of light k vector k and phase difference φ as a function of light k vector k.

Amplitude of S after input compensator: As(k) (vary from 0.78 to 1)

Amplitude of P after input compensator: Ap(k) (vary from 0 to 0.48)

Phase P-S after input compensator: φ1(k)

For one TIR reflection in waveguide-air interface, phase shift of S and P modes is simulated by Berreman method. The following were performed setting waveguide with index 1.55, and air with index 1, running the simulation program, saving the data of phase shift P— phase shift S φTIR(k). The phase shift of P-S is between 130 to 180 degrees in k vector space for one TIR. If many TIR are considered, for example about 100 TIR reflections, although the exact number of reflections will depend strongly on the k-vector of light in the waveguide and will vary over the output coupler region. A rough view can be obtained since the TIR phase shift for any incident angle, is a large number which is between 130 to 180 degrees. After so many times TIR, the phase difference between S and P modes, are randomly reset. Here, with the addition of 100 times TIR phase difference φTIR (k) with the phase difference between S and P mode after input compensator φ1(k), to obtain the phase difference of S and P modes in waveguide before the output coupler. Amplitude of S after 100 TIR: As(k)

Amplitude of P after 100 TIR: Ap(k)

Phase P-S after 100 TIR: φ1(k)+φTIR(k)*100

Using these amplitude and phase differences to output compensator before the output coupler,

Amplitude of S before output compensator: As(k)

Amplitude of P before output compensator: Ap(k)

Phase P-S after before output compensator: φ1(k)+φTIR(k)*100

Using wavelength 633 nm, 532 nm and 457 nm, the efficiency can be obtained. With shorter wavelengths, the efficiency drops in right edge of FOV, which corresponds with large polar angle in waveguide. Since the thickness of compensator is constant designed for 532 nm, when light with shorter wavelength goes in, the phase retardation is larger for all angles. The larger polar angle it has, the larger retardation it has, so in right edge of FOV, it is larger than required retardation to convert SLP to RHC and induced low efficiency. See longer wavelength 633 nm, the low efficiency appears in left edge of FOV, and condition of green 532 nm wavelength is between red 633 nm and blue 457 nm with high efficiency area in middle of FOV.

The same device also works for RHC in, converted by the first compensator to PLP, then to LHC by the second compensator at the output. Or even using two different compensators in input and output to convert LHC/RHC to SLP/PLP then to LHC/RHC. In summary, with the design of compensator with optical axis out of X-Y plane, circular polarized light can be converted to linear polarized light propagating in the waveguide, which has advantages to avoid polarization state change by TIR. Several conditions of input and output couplers are provided in Table 1.

TABLE 1
relation of input, output polarization and compensator optical axis

| | | Polari- | | |
|---|---|---|---|---|
| Input | Input | zation | Output | Output |
| Polarization | Compensator | State in | Compensator | Polarization |
| State Before | Optical | Wave- | Optical | State After |
| Compensator | Axis/Degrees | guide | Axis/Degrees | Compensator |
| LHC | P: −26 A: 52 | SLP | P: −26 A: 52 | RHC |
| LHC | P: −26 A: −52 | PLP | P: −26 A: −52 | RHC |
| LHC | P: −26 A: 52 | SLP | P: −26 A: −52 | LHC |
| LHC | P: −26 A: −52 | PLP | P: −26 A: 52 | LHC |
| RHC | P: −26 A: 52 | PLP | P: −26 A: 52 | LHC |
| RHC | P: −26 A: 52 | PLP | P: −26 A: −52 | RHC |

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

1. A waveguide assembly comprising:
a waveguide comprising a first surface and a second surface;
an input deflection grating;
an output deflection grating; and
a first compensator layer on the first surface of the waveguide, the first compensator layer comprising a first material.

2. The waveguide assembly of claim 1, wherein the input deflection grating and the output deflection grating are located on the first surface of the waveguide.

3. The waveguide assembly of claim 1, wherein the input deflection grating and the output deflection grating are located on the second surface of the waveguide.

4. The waveguide assembly of claim 1, wherein the first compensator layer has an optical axis aligned perpendicular to a direction of light propagation in the waveguide.

5. The waveguide assembly of claim 1, further comprising:
a second compensator layer on the second surface of the waveguide, the second compensator layer comprising a second material selected from the group consisting of aligned liquid crystal reactive mesogens, birefringent polymers, and inorganic birefringent materials.

6. The waveguide assembly of claim 1, wherein the first compensator layer is continuous.

7. The waveguide assembly of claim 1, wherein the first material comprises aligned liquid crystal reactive mesogens.

8. The waveguide assembly of claim 1, wherein the first material comprises a birefringent polymer.

9. The waveguide assembly of claim 1, wherein the first material comprises an inorganic birefringent material.

10. An optical combiner comprising:
a transparent waveguide layer;
an input coupler attached to a first surface or a second surface of the transparent waveguide layer;
an output coupler attached to the first surface or the second surface of the transparent waveguide layer; and
a compensation layer attached to the first surface or the second surface of the transparent waveguide layer, the compensation layer comprising a material selected from the group consisting of aligned liquid crystal reactive mesogens, birefringent polymers, and inorganic birefringent materials.

11. The optical combiner of claim 10, wherein at least one of the input coupler and the output coupler comprises a polarization volume grating.

12. The optical combiner of claim 10, wherein the compensation layer has a thickness in a range of about 10 nm to about 100 pm.

13. The optical combiner of claim 10, wherein the material has a birefringence (ne-n0) in a range of about −0.5 to about 0.5.

14. The optical combiner of claim 10, wherein the compensation layer is attached to the first surface; and wherein the input coupler and the output coupler are attached to the second surface.

15. The optical combiner of claim 14, wherein the compensation layer covers the first surface between the input coupler and the output coupler.

16. The optical combiner of claim 14, further comprising a second compensation layer attached to the second surface between the input coupler and the output coupler.

17. An augmented display system comprising:
a display source; and
an optical combiner comprising:
a waveguide;
an input coupler on a first surface or a second surface of the waveguide, the input coupler configured to receive an image from the display source;
an output coupler on a first surface or a second surface of the waveguide, the output coupler configured to transmit the image to a user; and
a polarization compensator on a first surface or a second surface of the waveguide, the polarization compensator configured to correct polarization of light transmitted through the waveguide.

18. The augmented display system of claim 17, wherein the system is an augmented reality (AR) system or a heads up display (HUD) system.

19-20. (canceled)

21. The waveguide assembly of claim 1, wherein the first material comprises a birefringent material.

22. (canceled)

23. The waveguide assembly of claim 21, wherein the birefringent material has a birefringence in the range of about 0.05 to about 0.5.

24. (canceled)
